(19) United States
(12) Patent Application Publication
(10) Pub. No.: US 2026/0148322 A1
(43) Pub. Date: May 28, 2026

(54) PROMPT MONITORING SYSTEM FOR GENERATIVE ARTIFICIAL INTELLIGENCE SYSTEMS

(71) Applicant: QWIND, LLC, Calabasas, CA (US)

(72) Inventors: Zoran Krunic, Thousand Oaks, CA (US); Nardo Manaloto, Pasadena, CA (US); Luis Ibarra, Fort Washington, MD (US)

(21) Appl. No.: 19/332,854

(22) Filed: Sep. 18, 2025

Related U.S. Application Data
(60) Provisional application No. 63/725,239, filed on Nov. 26, 2024.
(60) Provisional application No. 63/738,636, filed on Dec. 24, 2024.

(51) Int. Cl. G06Q 50/18

(52) U.S. Cl. CPC G06Q 50/184

(57) ABSTRACT

A prompt monitoring system for generative artificial intelligence systems comprises a repository of prompts and a prompt analysis application analyzing prompts based upon intellectual property issues.

### CROSS REFERENCE TO RELATED APPLICATIONS

This application claims the benefit of U.S. Provisional Patent Application No. 63/738,636 , entitled “PROMPT MONITORING SYSTEM FOR GENERATIVE ARTIFICIAL INTELLIGENCE SYSTEMS,” filed Dec. 24, 2024, and U.S. Provisional Patent Application No. 63/725,239 , “PROMPT MONITORING SYSTEM FOR GENERATIVE ARTIFICIAL INTELLIGENCE SYSTEMS,” filed Nov. 26, 2024, both of which are incorporated herein by reference.

### BACKGROUND OF THE INVENTION

### 1. Field of the Invention

This application relates to a prompt monitoring system for generative artificial intelligence systems.

### 2. Description of the Related Art

As generative artificial intelligence systems become more common, the intellectual property being created, applied, and implemented in conjunction with the use of these generative artificial intelligence system is not fully monitored. It is likely some of the intellectual property will be associated with the prompts being used by these generative artificial intelligence system as the produce output. As those skilled in the art will certainly understand a prompt is a user-provided instruction, command, question, or statement given to a generative artificial intelligence system to elicit a specific, desired output or response. Prompts often act as the starting point and guide for the generative artificial intelligence system, providing context and direction to help it generate content, solve problems, or perform tasks, with the quality and relevance of the output directly depending on the prompt's clarity, specificity, and detail. The present prompt monitoring system for generative artificial intelligence systems provides mechanisms for protecting, monitoring, and understanding the intellectual property associated with the use of these generative artificial intelligence systems.

### SUMMARY

In one aspect a prompt monitoring system for generative artificial intelligence systems comprises a repository of prompts and a prompt analysis application analyzing prompts based upon intellectual property issues.

In some embodiments the prompt analysis application identifies prompts that infringe existing patents, copyrights, or other intellectual property rights.

In some embodiments the prompt analysis application identifies patentable prompts.

In some embodiments the repository of prompts is a collection of prompts determined to infringe existing patents, copyrights, or other intellectual property rights.

In some embodiments prompts in the repository of prompts also includes prompts that have been denied intellectual property protection and are considered to be in the public domain.

In some embodiments the prompts maintained in the repository of prompts result from study of U.S. Patent & Trademark Office (USPTO) information, Copyright Office information, information from other government agencies responsible for intellectual property, court decisions concerning intellectual property, legal partners, and prompt creators.

In some embodiments the prompt analysis application includes a Large Language Model.

In some embodiments the Large Language Model is created by fine-tuning an existing Large Language Model with data, training a Large Language Model from scratch, building conventional Machine Learning models, or prompt engineering with a multi-shot approach, or combined with embedding searches.

In some embodiments the repository of prompts is curated by legal partners and prompt creators studying patents issued by the USPTO and copyright registrations issued by the Copyright Office of the Library of Congress, and identifying those relating to prompts.

In some embodiments the prompt analysis application studies new prompts to determine whether they are patented, copyrighted, or otherwise protected by intellectual property.

In some embodiments a human or AI prompt creator submits prompts to the prompt analysis application for consideration as to whether they are patented, copyrighted, or otherwise protected by intellectual property.

In some embodiments a generative artificial intelligence system is connected to the repository of prompts and the prompt analysis application.

In some embodiments the prompt analysis application determines a score relating to the likelihood a prompt presents a problem regarding intellectual property.

In some embodiments a score that exceeds a predetermined threshold is considered to present a problem with regard to intellectual property.

In some embodiments the prompt monitoring system further includes an interface providing screen notifications that allow for a user to request patent evaluation options, screen notifications that warn a user when a potential issue is identified, and/or options to explore new patent ideas associate with a given prompt.

In some embodiments the prompt analysis application implements a vector processing system in its decision making process when determining a likelihood for either infringement or patentability.

In some embodiments a prompt is first input into the prompt monitoring system and a vector check is performed to determine how closely the input prompt matches an existing patented prompt.

In some embodiments vectors are generated based upon different information.

In some embodiments an abstract of a patent is used to produce a short embedding vector.

In some embodiments the full text, description, and images of a patent are used to produce a long embedding vector.

Other objects and advantages of the present invention will become apparent from the following detailed description when viewed in conjunction with the accompanying drawings, which set forth certain embodiments of the invention.

### BRIEF DESCRIPTION OF DRAWINGS

FIG. 1 is a schematic of the present prompt monitoring system.

FIG. 2 shows user interaction flow in accordance with the prompt monitoring system.

FIG. 3 shows an algorithm for an infringement check with offline option.

FIG. 4 shows an algorithm for an infringement check with offline option through an Application Programming Interface (API).

FIG. 5 is a flow chart showing application communication with repository and legal partners in accordance with the prompt monitoring system.

FIG. 6 is a flow chart showing two main configuration options for verification API in accordance with the prompt monitoring system.

FIG. 7 is a flow chart showing a sequential option: verification first, then processing in accordance with the prompt monitoring system.

FIG. 8 is a flow chart showing a parallel option: verification and processing in parallel in accordance with the prompt monitoring system.

FIG. 9 shows an algorithm for a Two-Tier Vector Retrieval Pipeline.

FIG. 10 shows a two-tier algorithm for retrieval (Search and Reranking) of the most similar.

FIG. 11 shows an algorithm for a Generic Encoder—Agnostic Pipeline.

FIG. 12 shows an algorithm for Head Truncation/Matryoshka.

FIG. 13 shows an algorithm for Linear Projection (Single Encoder).

FIG. 14 shows an algorithm for Dual Encode (Big+Small).

FIG. 15 shows an algorithm Auto-Tune ANN Recall.

FIG. 16 shows an algorithm for Two-Tier With Dynamic Fallback.

FIG. 17 is a schematic showing patentable vs. patent violation.

FIG. 18 shows a user option for patent evaluation.

FIG. 19 shows a user screen with an infringement warning.

FIG. 20 shows a user option for exploring similar ideas.

FIG. 21 is formal pseudo-code for periodic update of a patented prompt database from the main (USPTO) database.

FIG. 22 is a more detailed version of the LLM_ExtractPrompt algorithm that shows one possible way to extract prompt text from description and/or claims of a patent

FIG. 23 is a flow chart showing a combined vector search for better performance in accordance with the prompt monitoring system.

FIG. 24 is a flow chart showing an embedding vector search for different patent components in accordance with the prompt monitoring system.

FIG. 25 is a flow chart showing an embedding search in accordance with the prompt monitoring system.

FIG. 26 is a flow chart showing a multi-vector retrieval with the threshold in accordance with the prompt monitoring system.

FIG. 27 is a prompt illustrating the usage of confidence and JSON format (an open standard file format and data interchange format) to obtain desired response format suitable for automated downstream processing

FIG. 28 is an example of a Python code class that could be used to obtain return data in exact format of that class instance; confidence could be included as part of that structure.

FIG. 29 shows an algorithm a sequential processing pipeline.

FIG. 30 shows an algorithm for a parallel processing pipeline.

FIG. 31 shows an algorithm for a utility function used in sequential and parallel pipelines.

FIG. 32 is an Illustration of embedding vectors space.

FIGS. 33, 34, and 35 show algorithms for the Shared Helper Routines as applied in the algorithms disclosed with reference to FIGS. 29, 30, and 31.

### DETAILED DESCRIPTION

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as a basis for teaching one skilled in the art how to make and/or use the invention.

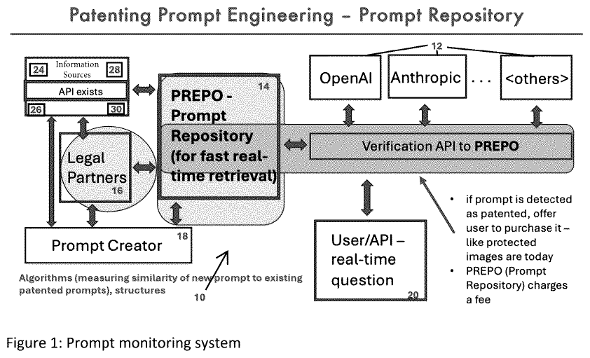

Referring to FIGS. 1, 3 and 4, a prompt monitoring system 10 for generative artificial intelligence systems 12 is disclosed. The prompt monitoring system 10 provides for fundamentally real-time prompt checks against a repository of prompts. With accelerated checks regarding prompts, the present prompt monitoring system 10 results in a system that allows billions of prompt checks on a daily basis. By allowing for prompts to be checked, for example, in 100 milliseconds, the prompt monitoring system processes the checks at a speed allowing generative artificial intelligence systems 12 to make use of the system in an effective and efficient manner.

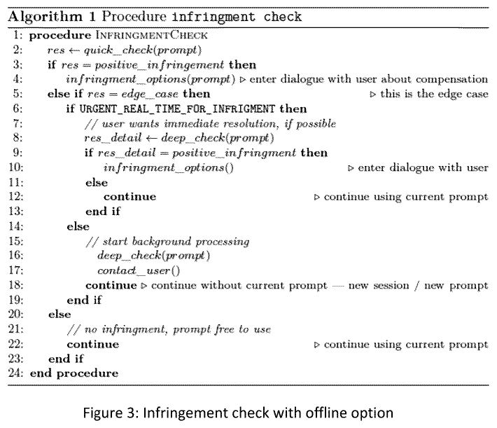

As is explained below in detail, the prompt monitoring system 10 combines a repository of prompts 14 with a prompt analysis application 22 (FIG. 3) to determine prompts that are problematic based upon intellectual property issues (for example, prompts that would infringe an existing patent, copyright, or other intellectual property rights), including, but not limited to, patent infringement, copyright infringement, etc. In addition to patent (including both utility and design patents) and copyright related intellectual property rights, it is appreciated other intellectual property rights might include, but are not limited to, trademarks, utility models, industrial designs, and trade dress. As will be explained below in detail, the prompt monitoring system 10 also allows for verification of a prompt's uniqueness, unobviousness, and potential for patentability. The prompt monitoring system 10 also provides for the insertion of prompts into the real-time repository.

The repository of prompts 14 is a collection of prompts known to be problematic based upon intellectual property issues (for example, prompts that would infringe an existing patent, copyright, or other intellectual property right, including, but not limited to, patent infringement, copyright infringement, etc.). In accordance with a disclosed embodiment, the collection of prompts making up the repository of prompts are stored in a database structure well known to those skilled in the art. In addition to a preliminary collection of prompts known to be problematic based upon intellectual property issues, the repository of prompts 14 also includes prompts identified during use of the prompt monitoring system 10 for use in analyzing subsequent prompt review requests (as is discussed below in detail). For example, once an incoming prompt p is identified as infringing on one or more patented prompts G={g1, g2, . . . , gn} (one prompt could infringe on more than one patented prompt, so the prompt monitoring system 10 uses set G), that infringing prompt is added to the repository of prompts 14 and could be used in similarity searches too.

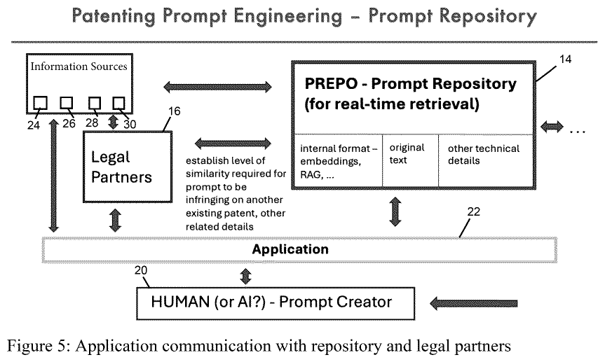

The repository of prompts 14 also includes prompts that have been denied intellectual property protection (similar to non-granted patents) and, therefore, would be considered to be in the public domain, assuming that the prompt author provides permission, with possible compensation. It is contemplated the prompt monitoring system 10 could offer as a service some of these prompts as useful user prompts for cases where they are useful and close to patented prompts, yet still denied patent protection themselves. The repository of prompts 14 is the product of analysis developed through the combined study of various information sources, including U.S. Patent & Trademark Office (USPTO) (FIG. 1 top left) patent & trademark information 24, Copyright Office information 26, information from other government agencies responsible for intellectual property 28, and court decisions concerning intellectual property 30 (FIG. 5), as well as legal partners 16 (that is, human intellectual property experts working within the system to optimize operation as discussed herein) and prompt creators 18. The legal partners 16 and prompt creators 18 consider USPTO patent and trademark information 24, Copyright Office information 24, information from other government agencies responsible for intellectual property 28, and court decisions concerning intellectual property 30, and work to measure the similarity of new prompts to those that are protected by intellectual property, including, but not limited to, patent infringement, copyright infringement, etc. Ultimately, the legal partners 16 and prompt creators 18 consider the USPTO patent and trademark information 24, Copyright Office information 26, information from other government agencies responsible for intellectual property 28, and court decisions concerning intellectual property 30, and identify existing patented, or otherwise prompts protected by intellectual property, prompts that are the stored in the repository of prompts 14 for use with prompts entered by users 20 of various artificial intelligence systems 12 (in the manner discussed below in more detail).

In accordance with a disclosed embodiment, the selection of prompts that might be granted intellectual protection is refined in the following manner. The legal partners 16 and prompt creators 18 consider USPTO patent and trademark information 24, Copyright Office information 26, information from other government agencies responsible for intellectual property 28, and court decisions concerning intellectual property 30, and work to measure the similarity of new prompts to those that are protected by intellectual property, including, but not limited to, patent infringement, copyright infringement, etc. Ultimately, the legal partners 16 and prompt creators 18 consider the USPTO patent and trademark information 24, Copyright Office information 26, information from other government agencies responsible for intellectual property 28, and court decisions concerning intellectual property 30, and identify existing patented, or otherwise intellectually property protected, prompts that are then stored in the repository of prompts 14 for use with prompts entered by users 20 of various artificial intelligence systems 12 (in the manner discussed below in more).

It is appreciated that the prompts of the users 20 of the generative artificial intelligence systems 12 could be entered in real-time or they may be off-line prompts. As such, implementation of the present prompt monitoring system 10 requires consideration of the time scales under which the prompt monitoring system might operate. In particular, the prompt monitoring system 10 might operate in a real-time environment offering results in milliseconds or tens or hundreds of milliseconds, the prompt monitoring system 10 might also operate in a near real time environment offering results in tens of seconds to minutes, or the prompt monitoring system 10 might operate in an off-line environment providing results in hours or days.

In general, users 20 create prompts in two ways, either real-time to get instant answers, or they develop them, and program the text of prompts into a programming framework, where responses from LLMs (Large Language Models)/AI (Artificial Intelligence) to their prompt are used for downstream processing, or presented to a user, or both. The off-line prompts are basically hard-coded, could be parametrized, thus developed, refined, and tested over time. Just like common programming, they are really a human-language expression of an algorithm for information extraction or the creation of new ideas, or other entities.

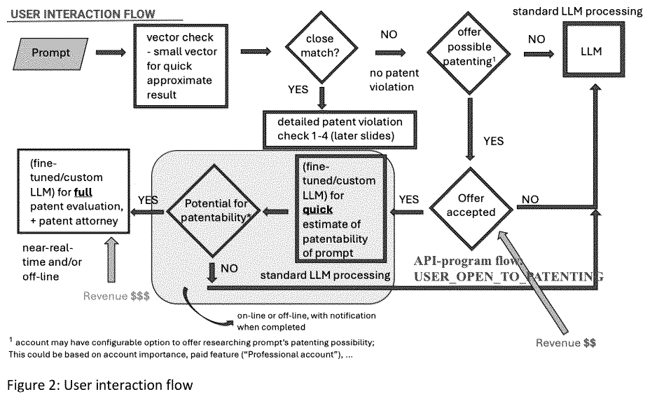

In accordance with a disclosed embodiment, and with reference to FIG. 2, the following presents an example of the flow, with optional API option facilitated through the provision of a specific parameter to the API call USER_OPEN_TO_PATENTING, for programming-issued prompts. More details about the API options and full range of possible parameters are discussed in later text below. It should be appreciated that many of the disclosed embodiments presented below relate specifically to patent-based systems and the analysis of data from the patent-based systems. However, it should be appreciated that similar techniques may be utilized the processing of data relating to other forms of intellectual property, including, but not limited to the processing of such associated intellectual property information coming from the Copyright Office, government agencies responsible for intellectual property, and court decisions concerning intellectual property.

In accordance with a disclosed embodiment, the prompt is initially subjected to a vector check (as explained below in detail). Where quick approximate results are desired, the vector check is simply a small vector allowing for quick approximate results. If the prompt is coming through the program—using API to submit prompts to the AI system, some adjustments are required.

If it is determined that the prompt is a close match with a prior patented prompt, the prompt monitoring system provides a detailed patent violation check which is discussed below in greater detail. If it is determined that the prompt presents no patent violations, the prompt monitoring system offers the user possible patenting. If the user selects NO, the prompt is submitted to an LLM. If the user selects YES, an offer is provided. If the user accepts the offer, the prompt is submitted to a fine-tuned/custom LLM for a quick estimate of patentability of the prompt. If, however, the offer is not accepted, the prompt is submitted to the LLM for standard LLM processing.

Once the fine-tuned/custom LLM evaluation of the prompt is completed, a determination regarding the potential for patentability is provided. In the event the determination is that the prompt has a low potential for patentability, it is once again submitted to the LLM for standard LLM processing. In the event it is determined that the prompt exhibits a high potential for patentability the prompt is submitted to a fine-tuned/custom LLM for full patent evaluation in conjunction with a review by a patent attorney (or other individual with expertise in relevant intellectual property issues).

It is appreciated that when the programming code with API is used to submit prompt, there may be no user to decide in real-time on any of the decisions; for example, a user accepting or rejecting an offer to try to patent a prompt that at preliminary level looks promising. As such, user flags need to be set in the code upfront, for example, USER_OPEN_TO_PATENTING, which flag would be used from the code in case this situation arises.

In accordance with a disclosed embodiment, the API parameters that replace user decision at real-time include:
USER_OPEN_TO_PATENTING—True/False; This corresponds to user checking/not checking the ‘Open to patenting?’ option on the screen.
USER_EXPLORE_SIMILAR_IDEAS—True/False; Corresponds to ‘Explore similar ideas?’ checkbox on the screen.
USER_ACCEPT_ADVERTISING—True/False; In case user's prompt is infringing on the existing patent(s), patent owner may offer user option to accept advertising and/or pay a fee to be able to use the prompt, this flag drives the advertising aspect of it.
USER_ACCEPT_FEE—True/False; In case user's prompt is infringing on the existing patent(s), patent owner may offer user option to accept advertising and/or pay a fee to be able to use the prompt - this flag drives the fee/per-per-use aspect of it.
USER_ACCEPT_ATTORNEY_HELP—True/False; In cases where off-line path is selected, this API flag would drive automated contact and meeting setup with a patent attorney and user.
URGENT_REAL_TIME_POSSIBLE_PATENT—True/False; To wait for result of possible patenting in real time, or to accept results being delivered later (email, popup, . . . -like ChatGPT has for Deep Research option).
URGENT_REAL_TIME_FOR_INFRIGMENT—True/False; To wait for result of possible patent infringement in real time, or to accept results being delivered later (email, popup) while not using the given prompt until the results are received with the final conclusion. That would apply when infringement is border-line, so more research is needed. If False, users would not be able to use prompt until resolution is provided.
URGENT_REAL_TIME_FOR_PATENTING—True, False; To wait for results of possible prompt patenting in real-time, or to accept results being delivered later (email, popup).

As to the creation of new ideas, it is appreciated this may include the writing of code, the production of pictures, printing new schematics, brainstorming an idea for a new machine, etc. While the Federal Circuit has initially determined that an AI software system may not be an inventor under the Patent Act, the underlying prompts may be patentable as the USPTO has explained “that while AI-assisted inventions are not categorically unpatentable, the inventorship analysis should focus on human contributions, as patents function to incentivize and reward human ingenuity. Patent protection may be sought for inventions for which a natural person provided a significant contribution to the invention, and the guidance provides procedures for determining the same.” 89 FR 10043. So those could also be checked against the repository of prompts 14, and with a relaxed response time. It is also appreciated that the submitter-checker (human or automated system) provide a flag saying ‘urgent-real-time’ or ‘not real-time’ that would flag it for delayed processing (potentially at a lower cost to the submitter which could provide resource savings when the system is used in large corporate environments).

In accordance with a disclosed embodiment where a relaxed real-time response to interactive user is desired, the following is contemplated. As discussed, it is appreciated that the submitter-checker (human or automated system) may provide a flag saying ‘urgent-real-time’ or ‘not real-time’ that would flag it for delayed processing. This would not generally apply to infringement checks, as that needs to be quick, but could be applied to more elaborate options in edge cases; for example, if a quick check shows an edge case, the user can accept to wait few minutes for more precise evaluation or a user can decide not to wait and exit the session for that prompt.

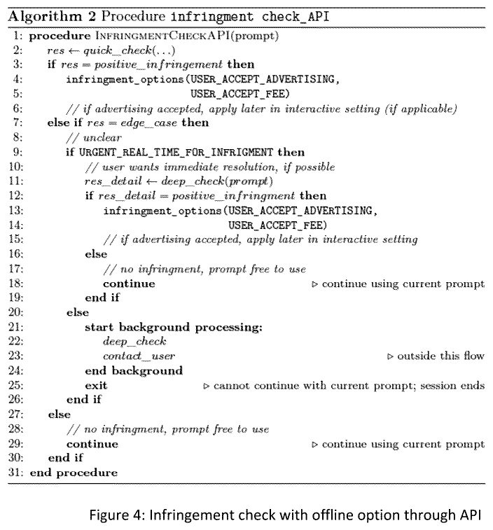

In such situations, the algorithm disclosed in FIG. 4 may be employed. The algorithm presented in FIG. 3 may also be written in plain text as follows:

```
  procedure infringement_check
    res = quick_check(prompt)
    if res == positive_infringement:
      # enter dialogue with user about compensation
      infringement_options(prompt)
    elif res == edge_case then
      # unclear
      if URGENT_REAL_TIME_FOR_INFRINGEMENT then
        # user wants immediate resolution, if possible
        res_detail = deep_check(prompt)
        if res_detail == positive_infringement then
        # enter dialogue with user
          infringement_options(prompt)
        else:
          continue
        end if
      else
        # start in background processing:
            deep_check(prompt)
            contact_user( )
        # end background
        # continue without current prompt - new session/new
prompt
        continue
      end if
    else
      # no infringement, prompt free to use
      continue
    end if
  end procedure
  The algorithm presented in Figure 4 may also be written in plain text
as follows:
  procedure infringement_check_API
    res = quick_check(...)
    if res == positive_infringement then
      infringement_options(USER_ACCEPT_ADVERTISING,
USER_ACCEPT_FEE)
      # if advertising accepted, apply later in interactive setting
    elif res == edge_case then
      # unclear
      if URGENT_REAL_TIME_FOR_INFRINGEMENT:
        # user wants immediate resolution, if possible
        res_detail = deep_check(prompt)
        if res_detail == positive_infringement then
          infringement_options(USER_ACCEPT_ADVERTISING,
USER_ACCEPT_FEE)
        # if advertising accepted, apply later in interactive setting
        else
        # no infringement, prompt free to use
          continue # continue using current prompt
        end if
    else
        # start in background processing:
          deep_check(prompt)
          contact_user( )
        # end background
        exit # cannot continue with current prompt; session ends
      end if
    else
      # no infringement, prompt free to use
      continue # continue using current prompt
    end if
  end procedure
```

The prompt monitoring system 10 also allows non-humans to submit prompts for checking whether the prompts are submitted for real-time processing or not, wherein the prompts are generated by software entities in the form of automated system. As such, the prompt monitoring system 10 contemplates 4 scenarios to prompt generation and submission—that is, real-time human users, real-time automated system users, not-real-time human users, and non-real-time automated system users. AI/LLMs are already used for improving their own prompts, so the prompt monitoring system 10 could be added to those processes and potentially licensed to them.

In addition to considering USPTO patent and trademark information, Copyright Office information, information from other government agencies responsible for intellectual property, and court decisions concerning intellectual property using traditional legal analysis techniques, it is contemplated the legal partners 16 and prompt creators 18 may employ artificial intelligence techniques to refine their determinations regarding problematic prompts wherein artificial intelligence is trained to analyze prompts using a ground truth data set of infringing intellectual property.

In accordance with the disclosed embodiments of the present invention the following main types of model preparation are used, and they could be combined in different ways as needed. The main types of model preparation include:
(1) Fine-tuning one of LLM models with a smaller amount of data or training an LLM from scratch, usually using a large amount of data;
(2) Building conventional Machine Learning models; or
(3) Prompt engineering with an optional multi-shot approach, in cases where full LLM training or fine-tuning may not be necessary.
(4) Different embeddings-based methods can also be used standalone or combined with other methods.

In addition, it is appreciated that a hybrid version of the above main types of model preparation might be implemented within the spirit of the present invention. In those cases, one could use a multi-agent approach to utilize solutions using the above approaches.

While various training techniques are disclosed herein, it is appreciated that new training methods may be developed and used for model training. For example, LoRA (Low-Rank Adaptation of Large Language Models) and KRAG (Knowledge Representation Augmented Generation) that adds knowledge graphs to the RAG (Representation Augmented Generation) approach have been recently developed and additional training techniques will certainly follow.

Prior to proceeding with this description of the main types of model preparation it should be appreciated that “positive patent examples” references those situations where a patent was approved and “negative patent examples” references those situations where a patent was not approved.

Considering first fine-tuning LLM models or training an LLM from scratch, one would use a sufficiently sized data set of positive and negative patent examples, in different configurations and proportions. The actual number of those examples would depend on the LLM itself, and the data available. Once the available LLM is fine-tuned with the examples provided, the LLM would be saved and used as needed. Fine-tuning of LLMs with custom specialized data is a well-known process - one example is OpenAI's post:
https://platform.openai.com/docs/guides/fine-tuning/faq, which is incorporated herein by reference. It is also appreciated that other options, for example, distillation or any new approaches that may be invented, could be employed.

As to building conventional Machine Learning models, the goal is to create a binary classification model, that can take any prompt, or any patent document intended for submission, and predict if that patent would be approved or not. The model would be trained on both positive and negative patent examples, from USPTO database(s) or others, as well as data from patent lawsuits, and other sources pertaining to the patent approval process.

Structuring of the patent data would need to be performed. This would involve extracting text into different features and using known labels—“patented” and “not patented” to form the data set. That data set is then split into multiple non-overlapping subsets—one for training the model and one more for testing on data unseen by the model during the training. It is also appreciated there could be additional data sets separated within the training set to facilitate the nuances of model training.

As to prompt engineering with an optional multi-shot approach, such a technique would be implemented by crafting instructions for a language model where the operator chooses to include multiple example input-output pairs (“shots”) within the prompt to further guide the model's response. This technique guides the responses output by the model by providing the model with a clear idea of the anticipated pattern or format. By employing this multi-shot approach, the model is trained with a focus on learning a desired pattern and generating consistent results. This technique is particularly advantageous when dealing with complex tasks or desired output formats.

In accordance with an embodiment of the present invention, and with reference to FIG. 3, the repository of prompts 14 is developed in the following manner. Considering the scenario where existing patented, or otherwise intellectually property protected, prompts are identified, for example, from the USPTO database, the legal partners 16 and prompt creators 18 study the patents issued by the USPTO 24, the copyright registrations issued by the Copyright Office 26 of the Library of Congress, etc. and identifies those relating to prompts. Those prompts identified as being patented, copyrighted, or otherwise protected by intellectual property are added to the repository of prompts 14.

In summary, the prompt monitoring system 10 loads patented prompts from USPTO to the repository of prompts 14. The repository of prompts 14 would, once functional, still require this external data loading, as not all prompts may be patented using the prompt monitoring system 10 presented here, but rather one user would work directly with patent attorneys, so that the prompt monitoring system 10 would not have a chance to see it. That way the prompt monitoring system 10 would provide violation guard even if patented prompt originated elsewhere. Loading would happen from the USPTO database, periodically.

The prompts determined to be problematic are stored in the repository of prompts 14 for use in conjunction with a prompt analysis application 22 that considers whether prompts entered by real-time users of various generative artificial intelligence systems 12 are potentially infringing intellectual property associated with prior prompts and/or whether intellectual property protection might be available for the prompts.

Considering the repository of prompts 14 in accordance with one embodiment, the prompts could be looked at as an algorithm for information extraction from LLM [+document(s)], expressed in (English) language. The prompts could also be looked at as an algorithm for the creation of new ideas, or other entities, including, but not limited to, the writing of code, the production of pictures, printing new schematics, brainstorming an idea for a new machine, etc. As discussed above, the problematic prompts would be, for example, prompts that would infringe an existing patent, copyright, or other intellectual property right, including, but not limited to, patent infringement, copyright infringement, etc. The repository of prompts 14 may also include prompts that have been denied intellectual property protection and, therefore, would be considered to be in the public domain. It is also possible real-time translation could be performed and checked against the easiest-to-match language used by the USPTO, that is, English. With this in mind, it is appreciated that the prompt monitoring system 10 is not language dependent and could be implemented in various languages so long as training is performed for separate LLM/AI models for other languages.

Considering now the scenario where new prompts are studied to determine whether they are patented, copyrighted, or otherwise protected by intellectual property, a human or AI prompt creator 18 submits various prompts to the prompt analysis application 22. The prompt analysis application 22 is developed with input from the USPTO API, Library of Congress (Copyright Office) API, court decisions relating to intellectual property, the legal partners 16 working to analyze intellectual property protection associated with prompts, and information already found in the repository of prompts 14. For example, information such as internal formatting, embeddings, RAG (retrieval augmented generation), original text, and other technical details may be stored in the repository of prompts 14 and utilized by the prompt analysis application 22 in making determinations as to those prompts that raise issues with regard to intellectual property. The main goal for real-time operation of the system is not to determine if the prompt is patentable, but rather to see if it infringes on existing patented prompt in the repository of prompts 14—which could be determined fairly well by RAG search or other related methods.

With regard to the work of the legal partners 16 associated with the development of the prompt analysis application 22, the legal partners 16 establish levels of similarity required for a prompt to be infringing upon another existing patent, as well as other details related to the analysis associated with a determination as to whether a prompt raises issues with regard to the intellectual property of third parties. The levels of similarity are based upon knowledge within the intellectual property legal field based upon court decisions, laws and regulations of the U.S. Patent and Trademark Office, the Copyright Office, and other government agencies responsible for handling intellectual property issues.

The present invention considers nuances and details for prompts, minimum level of details required through the present prompt monitoring system 10.

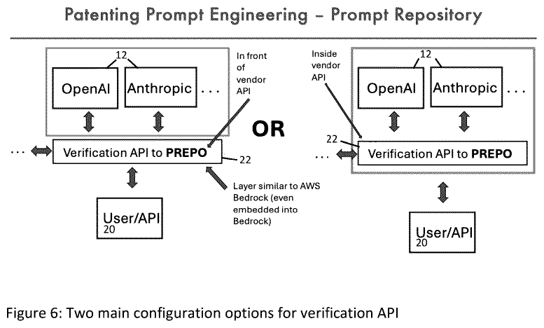

Referring to FIGS. 6, 7, and 8, once the repository of prompts 14 is developed, a user submits real-time prompt to a generative artificial intelligence system 12, for example, OpenAI, Anthropic, etc. However, and prior to being submitted to the generative artificial intelligence system 12 for analysis, the prompt is verified by the prompt analysis application 22 of the present prompt monitoring system 10 (that is, the verification system of the present prompt monitoring system 10) as not being protected by intellectual property (via an API providing access to the information stored in the repository of prompts 14). The prompt analysis application 22 provides a real-time check against the repository of prompts 14. If the prompt is detected as being protected by intellectual property, the user is provided with an offer to purchase a license to use the prompt—like protected images are today—and repository of prompts 14 charges a fee. The pseudo-code and flow for different scenarios is described above with reference to FIG. 2.

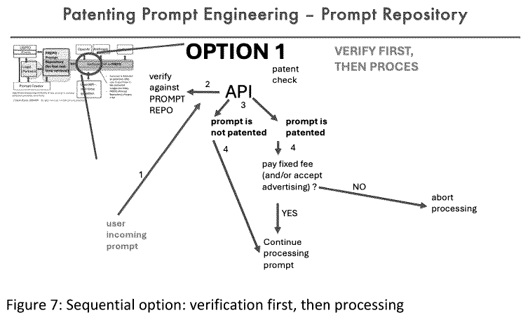

In accordance with a first disclosed embodiment, the prompt analysis application 22 functions in the following manner (see FIG. 7). The user initiates a prompt with the generative artificial intelligence system 12 via the API of the generative artificial intelligence system 12. The prompt analysis application 22 then verifies the prompt against the repository of prompts 14. In accordance with a disclosed embodiment, the prompt analysis application 22 determines a score relating to the likelihood the prompt presents a problem regarding intellectual property, wherein a score that exceeds a predetermined threshold is considered to present a problem with regard to intellectual property.

If the prompt is determined to not be protected by intellectual property, an instruction is sent to the generative artificial intelligence system 12 that the prompt may be processed and the results sent to the user. If it is determined that the prompt does raise problems regarding intellectual property, the user is asked to pay a fixed fee and/or accept advertising. In the event the user accepts the fixed fee or advertising, the prompt is processed, and the results are sent to the user. If the user refuses to pay the fixed fee and/or accept the advertising, the prompt is aborted, with a relevant message informing the user about it. If the prompt is coming in programmatically through the API call, processing parameter/codes are used to handle decision making that a user would interactively do in real-time. The handling is continued programmatically.

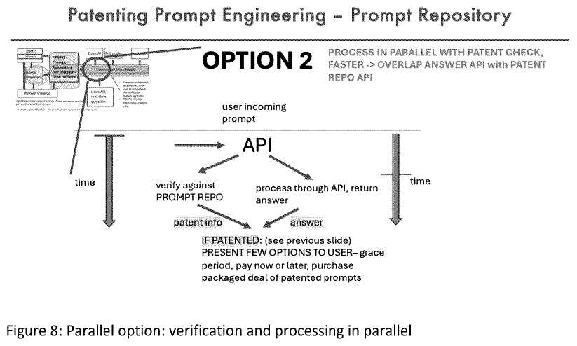

In accordance with a second disclosed embodiment, the prompt is processed by the prompt analysis application 22 in parallel with the patent check (see FIG. 8). This process is faster and is achieved by overlapping the answer API with the API of the repository of prompts 14.

In particular, the incoming user prompt is processed using the API of the prompt analysis application 22. The prompt is simultaneously verified against the repository of prompts 14 and processed through the API of the generative artificial intelligence system 12 for the answer. As with the prior embodiment, the prompt analysis application 22 determines a score relating to the likelihood the prompt presents a problem regarding intellectual property, wherein a score that exceeds a predetermined threshold is considered to present a problem regarding intellectual property. The prompt analysis application 22 may also provide an indication relating to the limitations of a patent or other form of intellectual property that presents a problem and resulted in the threshold score being applied. RAG search is in tens to hundreds of milliseconds.

Considering now the vector search, it is expected and has been demonstrated that in vector databases/data sets with 100-200-300 million vectors, the top 100 results for a given search input text embedding could be retrieved in under 30 milliseconds, resulting in high recall >0.9. For near 100% recall, these go up to 100-milliseconds, which is still quite fast.

In Stage 2, the top 100 candidate vectors are used for exact distance calculation using higher dimensional embeddings—1024 or similar. That is super-fast and would generally be completed in under 1 millisecond. It is presumed fast GPU cards like NVIDIA A100 with 80 GBs of RAM would be utilized for such calculations.

With this foregoing in mind, it should be appreciated that MRL—Matryoshka approach are indexes where full dimension is for example 1024, but the first 128-dimensions serve as a compressed dimensional representation. It also means that 128-dimensional embedding is a truncated version of full 1024 embedding, thus this guarantees full alignment. This is due to the fact that MRL embeddings are trained to nest information so that the first 128 dimensions are a highly informative part of full 1024 embedding. MRL also retained 98+% of its accuracy with the first 128 dimensions, compared to full 1024 embedding.

This approach could be also scaled up well for high number of users or API calls.

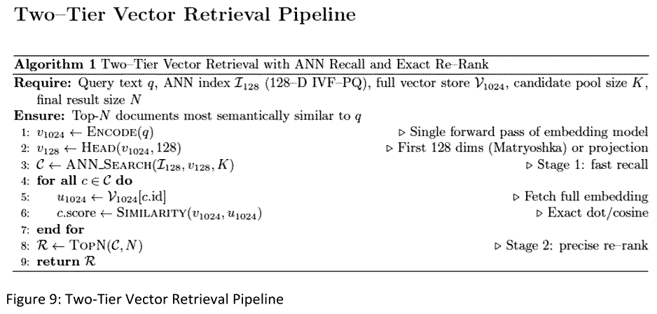

As to determinations regarding patent infringement, the key is the have new patent claims be such that they do not match all the elements in any of the already patented claims. The algorithm presented in FIG. 9 is contemplated for matching new patent claims with those patents claims that have already been granted by the USPTO.

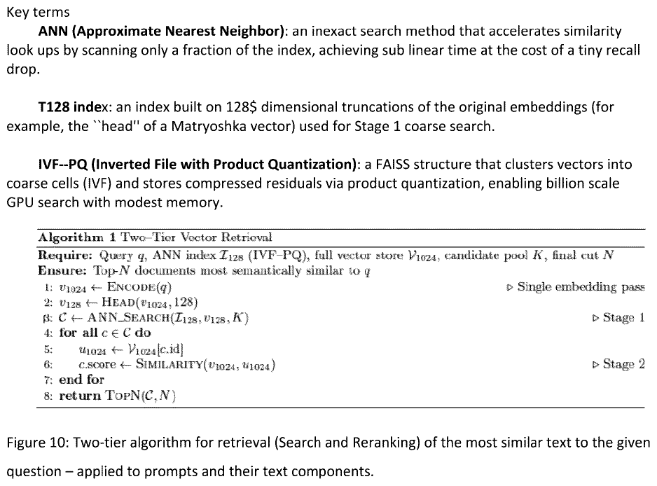

In accordance with another embodiment the algorithm presented in FIG. 10 is contemplated for matching new patent claims with those patents claims that have already been granted by the USPTO. This algorithm utilizes a Two—Tier Vector Retrieval Pipeline. The prompt monitoring system 10 splits retrieval into two stages: (i) a fast, low—dimensional coarse recall that surfaces a handful of promising candidates, followed by (ii) an exact re—rank on the full, high—dimensional embeddings to produce the final results. This architecture keeps latency in the millisecond range while recovering the accuracy of high—resolution vectors.

The algorithm of FIG. 10 may be written in text form as follows:

```
procedure two_tier_vector_retrieval(q, I128, V1024, K, N)
  # Input: query q
  # Data: ANN index I128 (IVF-PQ); full vector store V1024
  # Parameters: candidate pool K; final cut N
  # Ensure: Top-N documents most semantically similar to q
  v1024 = Encode(q)  # single embedding pass
  v128 = Head(v1024, 128)
  C = ANN_Search(I128, v128, K)  # Stage 1
  for each c in C do
    u1024 = V1024[c.id]
    c.score = Similarity(v1024, u1024)  # Stage 2
  end for
  return TopN(C, N)
end procedure
```

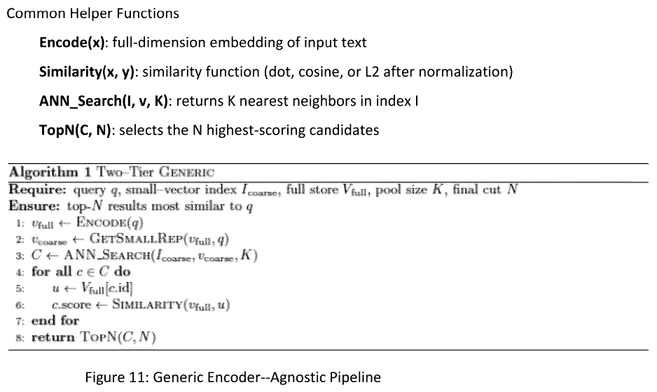

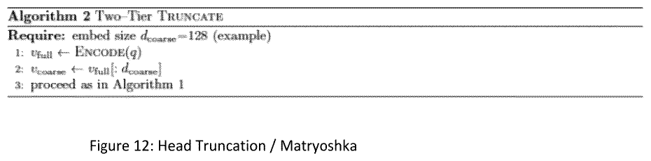

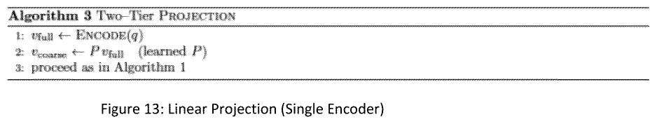

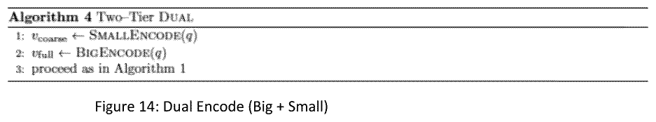

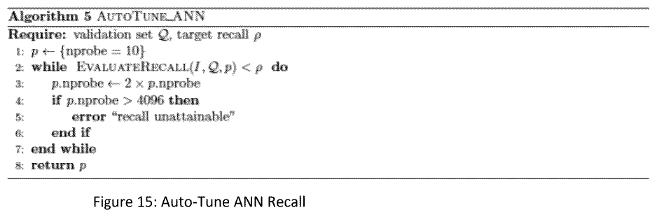

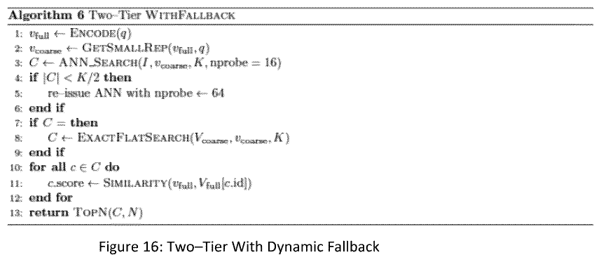

The methods above may vary somewhat due to changes in technology and newest methods may be used to improve efficiency and/or accuracy. A more general approach in accordance with a disclosed embodiment might utilize Two-Tier Vector Retrieval: Pseudocode Variants. This collects several pseudocode patterns for implementing a two—stage (coarse ANN recall->exact re-rank) retrieval system. The prompt monitoring system 10 can choose different variants of the algorithm with different embedding strategies. The algorithms used with Two-Tier Vector Retrieval: Pseudocode Variants are presented in FIGS. 11 to 16. These algorithms are more general two-tier algorithms for retrieval of the most similar text to the given question - applied to prompts and their text components.

The algorithms of FIG. 11 to 16 may be written in text form as follows:

ALGORITHM 1
Two-Tier Generic

```
procedure two_tier_generic(q, I_coarse, V_full, K, N)
  # Input: query q
  # Data: small-vector index I_coarse; full vector store V_full
  # Parameters: pool size K; final cut N
  # Ensure: Top-N results most similar to q
  v_full = Encode(q)
  v_coarse = GetSmallRep(v_full, q)
  C = ANN_Search(I_coarse, v_coarse, K)
  for each c in C do
    u <− V_full[c.id]
    c.score <− Similarity(v_full, u)
  end for
  return TopN(C, N)
end procedure
```

ALGORITHM 2
Two-Tier Truncate (Head Truncation/Matryoshka)

procedure two_tier_truncate(q, d_coarse=128)
# Input: query q
# Parameter: coarse embedding size d_coarse (example: 128)
# Ensure: Uses truncated vector head for coarse search
v_full = Encode(q)
v_coarse = v_full[:d_coarse]
proceed as in two_tier_generic
end procedure

ALGORITHM 3
Two-Tier Projection (Linear Projection)

```
procedure two_tier_projection(q, P)
  # Input: query q
  # Data: learned projection matrix P
  # Ensure: Uses projected coarse representation for search
  v_full = Encode(q)
  v_coarse = P * v_full
  proceed as in two_tier_generic
end procedure
```

ALGORITHM 4
Two-Tier Dual Encode

```
procedure two_tier_dual(q)
  # Input: query q
  # Data: small encoder; big encoder
  # Ensure: Uses independent encoders for coarse and full
embeddings
  v_coarse = SmallEncode(q)
  v_full = BigEncode(q)
  proceed as in two_tier_generic
end procedure
```

ALGORITHM 5
AutoTune_ANN

```
procedure autotune_ann(I, Q, rho)
  # Input: validation set Q; target recall rho
  # Data: index I
  # Ensure: Returns ANN parameters tuned to meet recall target
  p = { nprobe = 10 }
  while EvaluateRecall(I, Q, p) < rho do
    p.nprobe <− 2 * p.nprobe
    if p.nprobe > 4096 then
      error “recall unattainable”
    end if
  end while
  return p
end procedure
```

ALGORITHM 6
Two-Tier With Fallback

```
procedure two_tier_with_fallback(q, I, V_coarse, V_full, K, N)
  # Input: query q
  # Data: index I; coarse vector store V coarse; full vector store V_full
  # Parameters: pool size K; final cut N
  # Ensure: Top-N results with dynamic fallback strategies
  v_full = Encode(q)
  v_coarse = GetSmallRep(v_full, q)
  C = ANN_Search(I, v_coarse, K, nprobe=16)
  if |C| < K/2 then
    C = ANN_Search(I, v_coarse, K, nprobe=64)
  end if
  if C is empty then
    C = ExactFlatSearch(V_coarse, v_coarse, K)
  end if
  for each c in C do
    c.score = Similarity(v_full, V_full[c.id])
  end for
  return TopN(C, N)
end procedure
```

Once the prompt is processed by the prompt analysis application 22, the results are forwarded to the user with a few options. For example, the user may be provided with an answer under grace, with the option to pay now or later, with the option to purchase a packaged deal of patented prompts, etc. It is contemplated the owner of the patented prompt can setup the number of options within the prompt repository for the prompt user: pay a specific fee for each use of the prompt; pay a monthly fee for longer use of the same prompt—subscription model, could be annual too; accept advertising, and then the patented prompt owner would get the percentage of the advertising fees (this would require wiring in the companies that advertise their products using this channel); advertising model would not directly apply to API cases, but fees would; financial models involving patent attorneys to participate in the off-line follow ups; financial model for partial automation of the patent ideas exploration; financial model for partial automation of the patent ideas from white spaces.

It is appreciated that the prompt analysis application 22 may be positioned in front of the artificial intelligence system API, or the prompt analysis application 22 may be integrated with the API of the generative artificial intelligence system 12. Where the prompt analysis application 22 is in front of the API of the generative artificial intelligence system 12, it is layered similar to AWS Bedrock or even embedded into AWS Bedrock but not limited to AWS Bedrock approach details.

The process of the prompt analysis application 22 might also verify prompt uniqueness and insert the prompt into the real-time repository of prompts 14 for use against future prompt verification requests and for consideration relating to the pursuit of future intellectual property protection regarding the unique prompt.

In accordance with an embodiment of the present invention, and as discussed above, the present prompt monitoring system 10 may be used to determine in real-time whether intellectual property protection is available for users of generative artificial intelligence systems 12. As such, the prompt monitoring system 10 performs distinct, but related, tasks that are necessary in the analysis of intellectual property. That is, and as discussed above, the prompt monitoring system 10 identifies prompts that are problematic based upon intellectual property issues (for example, prompts that would infringe an existing patent, copyright, or other intellectual property right) and, as discussed below, the prompt monitoring system 10 determines whether intellectual property protection might be available.

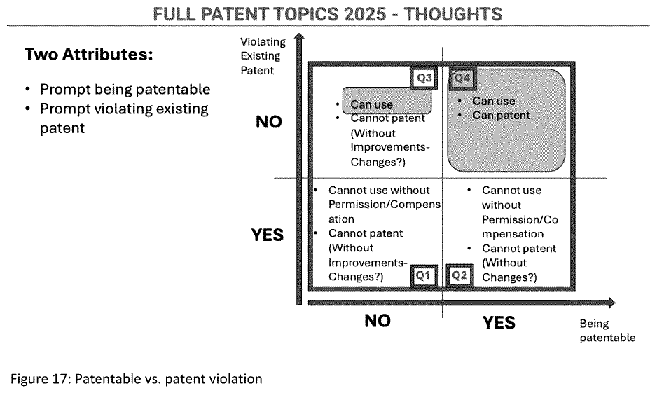

As discussed above, the present prompt monitoring system 10 may be utilized to both determine potential infringement of existing patents and to determine potential patentability of new developments. As those skilled in the art well appreciate, determinations regarding infringement and patentability require distinct evaluations and result in distinct outcomes with distinct advice for proceeding. For example, and with reference to FIG. 17, where it is determined that a new prompt violates an existing patent and does not offer the potential for patentability, the user cannot use the prompt without obtaining the permission of the patent owner and cannot patent the prompt. In case of an API, specific status codes are returned to allow for programmatical handling of different scenarios. Specific four cases are elaborated here:
1. Quadrant Q1: new prompt violates an existing patent and does not offer the potential for patentability; the user cannot use the prompt without obtaining the permission of the patent owner and cannot patent the prompt. In case of an API, specific status codes are returned to allow for programmatical handling of different scenarios. TODO: API return stats algo flow—similar to user but outline the differences.
2. Quadrant Q2: Where it is determined that the new prompt violates an existing patent and does offer the potential for patentability, the user cannot use the prompt without obtaining the permission of the patent owner, but the user could patent the idea. This might take place where the new prompt represents an improvement over a preexisting prompt that was previously patented. The new prompt includes additional features not contemplated in the preexisting prompt and enhances the functionality of the preexisting prompt in a manner that is novel and unobvious.
3. Quadrant 3: Further still, where it is determined that the prompt does not violate an existing patent and does not offer patentable innovation, the user may proceed to utilize the prompt but may not obtain patent protection for the PA prompt.
4. Finally, and considering the situation where the prompt does not violate an existing patent but does include patentable features, the user may freely utilize the prompt and may proceed to obtain patent protection.

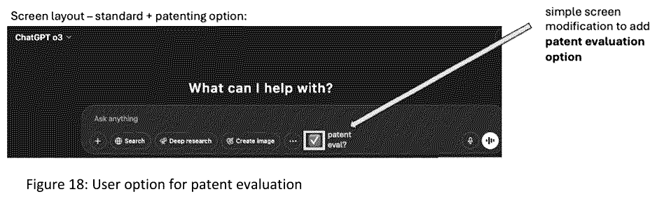

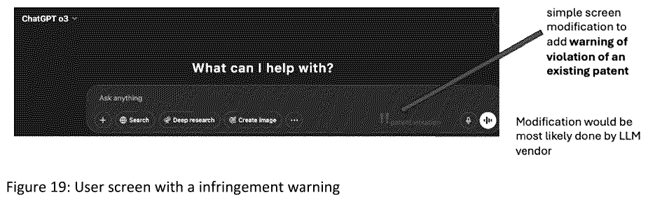

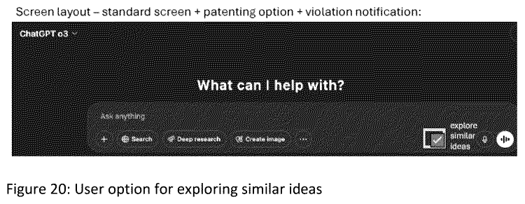

As such, and with reference to FIGS. 18, 19, and 20, the interface of the present prompt monitoring system 10 makes use of screen notifications that allow for a user to request patent evaluation options and screen notifications that warn a user when a potential issue is identified. In accordance with yet another embodiment, the user may be provided with the options to explore new patent ideas associate with a given prompt. This would be most relevant if the prompt was determined to be potentially patentable and in a sparse region of current ideas (see embedding vectors plots). In such a situation, the LLM or other methods would be used to generate concepts and ideas whose embedding vector(s) are close to the given embedding vector of the current prompt.

Considering the need for multiple determinations regarding both infringement and patentability, the present prompt monitoring system 10, in accordance with a disclosed embodiment, implements a vector processing system in its decision making process when determining the likelihood for either infringement or patentability. As those skilled in the art will appreciate, vector analysis employs a plurality of vectors representing data associated with subject matter of interest as both magnitude and direction. Vector database would contain multiple indexes builds, with one for length-aware vectors and one with length-agnostic vectors, thus supporting multiple metrics later, for both direction-only search as well as intensity+direction search in some other cases. Both could be carried out in parallel in some cases, to allow for more nuanced and precise retrieval. Thus, information relating to prompts may be expressed as vectors and subsequently compared to identify potential patent related issues corresponding to the prompts at issue. Patented prompts would be pulled into this repository, so all patents in this repository are prompts (thus no need to separate prompts from other patents). The repository update from USPTO database has the logic/algorithm to pull in the patented prompts only and avoid regular patents.

The following explains how the repository of prompts is updated by accessing information from the USPTO database.

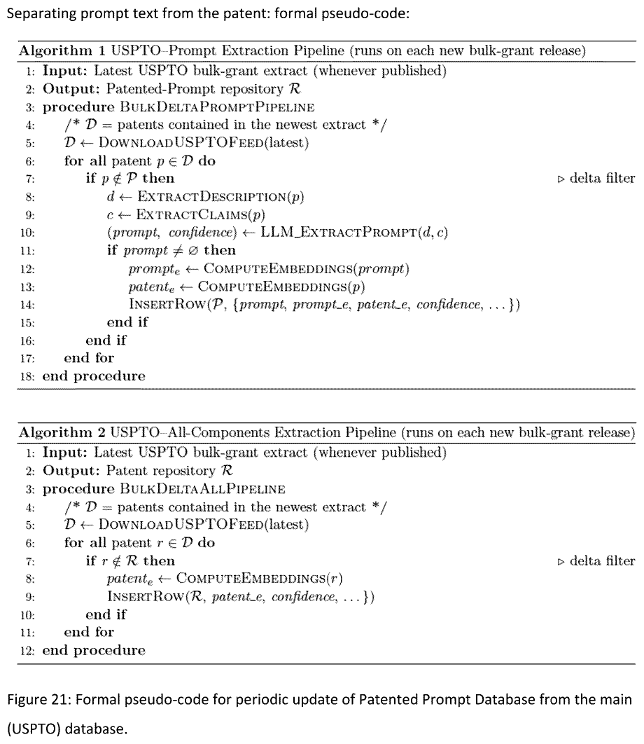

The prompt text is separated into a separate table/index of embeddings and plain text for easier check by real-time prompts. The patented prompt would have the exact prompt text, plus other elements that cover subject-matter eligibility. It is presumed that the prompt text would have to be specified in the detailed description of the patent. One can then use the LLM to separate that text from patents detailed description text (some parts of the prompt might be in claims too). A disclosed algorithm for this process is presented below and disclosed with reference to FIG. 21.

### Algorithm 1

Daily or maximum possible frequent extract from USPTO database

It is likely to contain about 1000 patents, as annual granted utility patents in USA are about 300 k+. So even with few times more than that is easy to process daily.

Extract granted patents information for all new/delta patents not in the patented prompt database already.

Extract their detailed description.

Extract claims.

Run LLM against each of detailed description and claims to extract prompt text itself. Most recent LLMs will be able to handle that easily.

It should be noted that the pseudo-code for periodic update as shown in FIG. 21 has two versions—one for update of the prompt repository P, the other for update of the general patent repository R. Updates would happen periodically at possible multiple, different frequences of updates, depending on the frequency of the primary source data updates (USPTO, . . . ) and their mechanism of action and notification of updates availability.

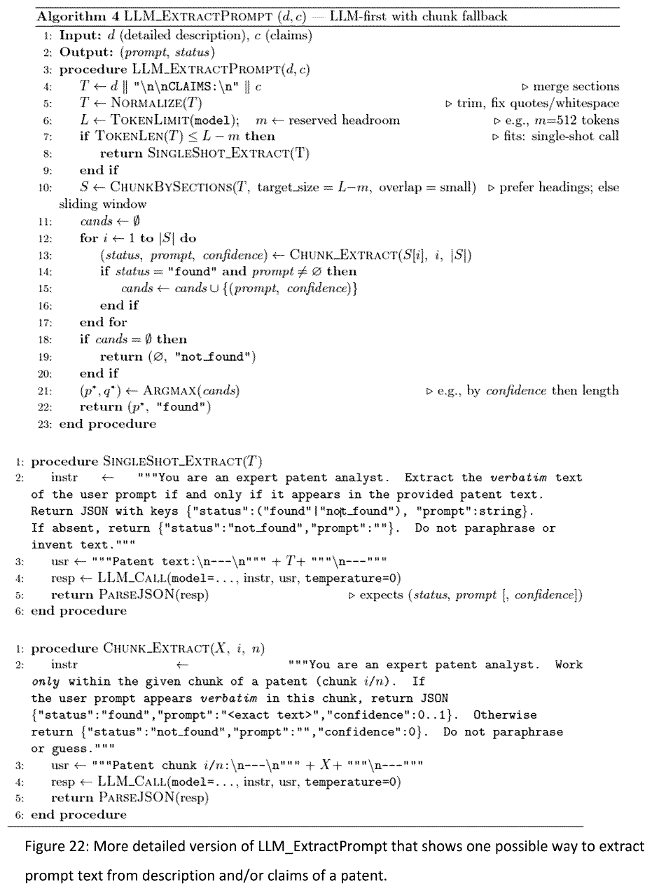

An algorithm for extracting prompts is shown in the FIG. 22. This shows one possible way to extract prompt text from description and/or claims of a patent

Other similar algorithms could be imagined. In either case, the goal is to extract exact and complete text of the patented prompt from the patent's fields—most likely to be in description and/or claims. Future patented prompt patents would also be reviewed to improve current described algorithm here; in case the actual text of the prompts is contained in a different layout in the future patents. That allows for real-time comparison of incoming prompt to the text of already patented prompts in the repository using text-to-text comparison, since the work of extracting prompt from the patents in USPTO was already completed during the daily/periodical incremental update of the prompt repository.

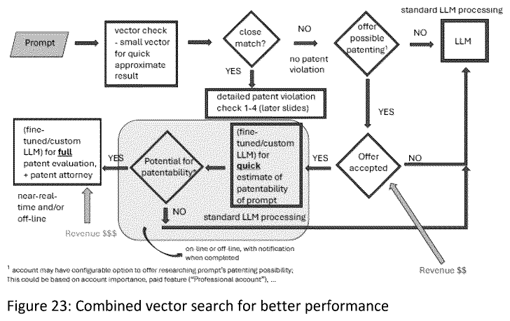

Referring to FIG. 23, and considering the implementation of the present prompt monitoring system 10 in conjunction with a vector processing system, a prompt is first input into the prompt monitoring system 10. Thereafter, a vector check is performed to determine how closely the input prompt matches an existing patented prompt. The vector check is performed as a small factor for quick approximate results.

As those skilled in the art will certainly appreciate, multiple vectors of different types and lengths (longer for slower or more precise matching) are produced. One vector may be produced for each part of the patent prompt, plus other vectors may be produced for different combinations, such as the abstract and image of a patent. It is also appreciated that general patents could be vectorized based upon a patent's abstract, full text, images, claims, specification, each with more than one vector for enhanced search. and with the vectors calculated, those vectors closest to the prompt embedding are considered as potential patents that might be violated by the user's prompt. It is also considered to use MRL—Matryoshka embeddings, for models that have that option available, as one possible approach. It allows for flexible dimensional sub-setting—for example using 128-dimension search first against 128-dimensional subset of 1024-dimensional vectors in the database, or using 256, or 512, allowing for different speeds and precisions at multi-level search, optimizing precision and response time simultaneously. Different indexes, in vector databases, like faiss and others support that approach. It does come at the cost, as it requires (as of this writing) that each of the query sub-dimensions has to be stored separately in the database—so for example, 128-dimensional subset of MRL-trained embedding model would need to be stored as a separate index in the database.

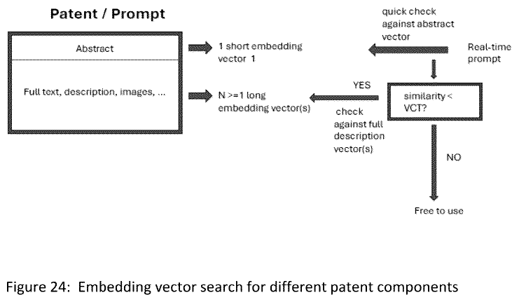

As shown in FIG. 24, and as briefly discussed above, vectors may be generated based upon different information. For example, a patent's title, abstract, claims, description, drawings, images all could be vectorized and searched against. For each of those, multiple dimension vectors could be created, using different models, some of which support MRL. That allows for variable (MRL) and multiple dimensional searches against each of the main patent components, in any number of different scenarios. In the event no similarity is found, the user of the prompt can be free to assume that there is minimal likelihood of infringement.

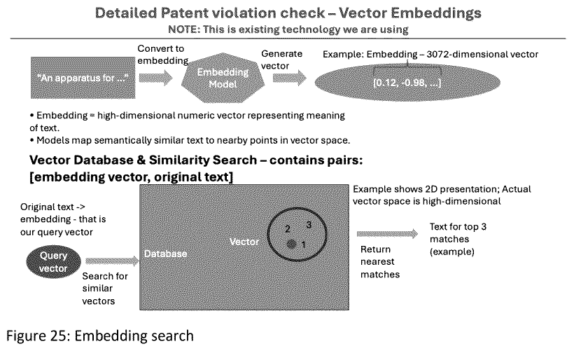

By way of example and with reference to FIG. 25 the vector check functions in the disclosed manner.

Based on today's technology, and based on the today's reported material from NVIDIA, it can be expected that string performance, if using high-end GPU cards, like H100 for example, but not limited to, as new models, will keep appearing on the market and cloud—like AWS for example.

Approach itself is to use vector retrieval in a two-stage process. First, a coarse search assigns each query to the nearest clusters using an inverted file index (IVF). Then, a fine search is performed only within those clusters. In IVF-Flat, the fine stage compares queries against full vectors. In IVF-PQ, vectors are stored in a compressed product quantization (PQ) format, so the fine search uses PQ codes and look-up tables to speed distance calculations. IVF-PQ can also apply an optional refinement step (reranking) that recomputes exact distances on shortlisted candidates, restoring accuracy lost to PQ compression. From the performance perspective, it is commonly reported in queries per second (QPS) vs. recall trade-offs (recall is ratio between obtained positive matches vs all existing positive matches; we want it to be as close to 1 as possible, indicating very few if any misses). IVF-Flat on an H100 reaches >99% recall by probing ˜1% of clusters. This works 10-20 times faster than only using CPUs. IVF-PQ enables 4-5× index compression, and in certain configurations achieves 3-4× higher QPS than IVF-Flat, thanks to reduced memory bandwidth needs. Recall typically drops under heavy compression, but refinement ×2 (“×2” refinement means that if we want k neighbors, IVF-PQ first retrieves 2 k candidates, then reranks them using exact distances, and keeps the best k) can lift recall back to ˜0.99 with only ˜25% QPS cost. Overall, IVF-Flat offers maximum accuracy, while IVF-PQ balances compression and higher throughput for billion-scale, real-time retrieval.

Where it is desired to scale up the number of users, the following may be considered:
A single A100/H100 GPU running a 128-D IVF-PQ index can serve ˜1 k-5 k QPS (queries/sec) on a 300 M-vector corpus while keeping tail-latency ≤30 ms (milliseconds).
Stage-2 re-rank is sub-millisecond, so capacity planning is driven almost entirely by the Stage-1 ANN kernel.
Throughput scales linearly with replicas: add N identical GPU nodes holding the same in-memory index and total QPS≈N×QPS_single (QPS of a single instance).
A stateless load-balancer simply round-robins incoming requests; no cross-node coordination is required because each node has the full index.
Example: 8 replicas×5 k QPS≈40 k QPS, enough for ˜50 k concurrent users issuing 1 q/s with headroom.

Currently OpenAI gets 2.5 billion prompts per day, or about 30 k prompts per second. Peak rate maybe 3-5 times more—so around 150,000 prompts per second. That means we would need 24 replicas per above calculation. Or 50-100 for extra headroom and growth, including Anthropic, others. Both Anthropic and Google Gemini receive less prompts than OpenAI, so going from 24 up to 100 replicas should provide ample space for current prompt repository. Clouse cost is around $5/hour, so that implies $500/hour for GPU cards. Plus RAM, CPUs, storage . . . .
Latency stays flat—each node still looks up locally, so P99 (‘P99’ means that 99% of the search completes in tens of ms) remains in the tens-of-ms range even at high traffic.
If the index no longer fits one GPU, shard horizontally (e.g., 4 shards×2 replicas). A query is fanned out to all shards; latency rises only a few ms because shards search in parallel.
Matryoshka (or any truncation) shrinks memory and halves encoder cost but doesn't change the scaling law: capacity still grows with replica count.
The practical ceiling is usually GPU memory bandwidth; once HBM (High Bandwidth Memory) is saturated, we would need to add more replicas—not more CPU threads—to handle additional users.

Refinement (also called reranking) is a post-processing step. After IVF-PQ finds approximate neighbors using compressed vectors, refinement rechecks those candidates against the original full-precision vectors to correct errors introduced by compression. “×2” refinement means that if we want k neighbors, IVF-PQ first retrieves 2 k candidates, then reranks them using exact distances, and keeps the best k. This boosts recall (fraction of true nearest neighbors found). For example, recall might rise from ˜0.85-0.95 up to ˜0.99, essentially restoring near-perfect accuracy. The trade-off is that this extra rechecking step reduces throughput (QPS) by about 25% compared to running IVF-PQ alone. So, if IVF-PQ could handle 100 k queries/sec before, with refinement ×2 it might handle ˜75 k queries/sec.

The following explains Recall measure for vector search.

Recall is a critical metric for evaluating the performance of vector embedding databases, especially in the context of similarity search and Approximate Nearest Neighbor (ANN) algorithms.

Recall importance:
Measuring search accuracy: Recall measures the percentage of relevant results retrieved from a search. In vector search, “relevant” means the true closest matches to the query, also known as ground-truth neighbors.
Evaluating ANN performance: Vector databases often use ANN algorithms for faster searches, but ANN might not always find the absolute closest neighbors. Recall helps you evaluate how well an ANN algorithm performs compared to an exact (KNN) search, which guarantees finding the true closest neighbors.
Balancing speed and accuracy: When using ANN, you typically trade off speed for recall. A higher recall means fewer missed matches but can lead to slower query execution (QPS).
Ensuring relevant results: In applications like recommendation systems or image search, high recall ensures that most of the relevant items are retrieved, which is crucial for user satisfaction.

How Recall is Calculated:
Recall is calculated by dividing the number of true neighbors retrieved by the ANN by the total number of ground-truth neighbors.
For instance, if an ANN retrieves 80 of the 100 actual closest matches in its top- 100 results, the recall@100 is 80%.
The formula is Recall@k=(Number of ground-truth neighbors in ANN's top-k results)/k, where k is the number of results returned.

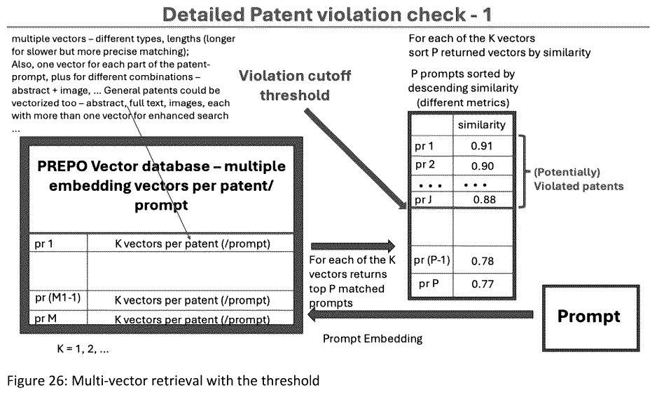

The prompt is entered and subjected to an embedding model. As those skilled in the art appreciate, vector embeddings are numerical representations of data that allow machine learning models to understand and process information. The vector embeddings convert complex data into a format that can be easily used in algorithms to identify patterns, measure similarities, and extract information. As a result, the embedding model produces various long numerical vectors; that is, vector embedding in accordance with the present invention results in high dimensional numeric vectors representing the meaning of text associated with the prompt. The vectors are then positioned in vector spaced by mapping semantically similar vectors to nearby vectors in the vector space. In particular, the vector database and similar searches produce pairs; that is, embedding vectors and original text. As shown in FIG. 26 the top three matches for a query vector are 1, 2, and 3, and are physically located nearest to the query vector. This information is then utilized in determining the most closely related prompts via the vector check.

### 1. Text Embedding Process

Input Text: “Patent for new apparatus”
Embedding Algorithm transforms text into numerical vectors
Vector Representation: [0.24, −0.62, 0.15, 0.47, −0.21, 0.84,0.32, 0.05, . . . ]
Vectors exist in high-dimensional space (typically 100-1000+dimensions)—so above vector would have 100-1000 numerical elements; Some new approaches use 3072-long vector—like OpenAI's text-embedding-3-large embedding.

### 2. Vector Database

Collection of pre-embedded text entries, each represented as vectors
Examples:
   “Device for sorting”→[0.22, −0.58, . . . ]
   “Method for analysis”→[0.41, 0.17, . . . ]
   “System apparatus”→[0.25, −0.61, . . . ]
   “Mechanical device”→[−0.12, 0.34, . . .]

### 3. Similarity Matching

Cosine Similarity: cos(θ)=A·B/(∥A∥·∥B∥)
   Measures angle between vectors (1.0=identical, 0.0=unrelated)
Search Results Example:
   “System apparatus”→0.94 similarity
   “Device for sorting”→0.86 similarity
   “Mechanical device”→0.65 similarity

### 4. Vector Space Visualization

Similar concepts cluster in vector space
Distance between vectors indicates semantic similarity
Enables “fuzzy matching” beyond exact keyword matching
Captures related concepts even with different terminology

### 5. Key Benefits & Alternative Methods

Benefits:
   Captures semantic meaning beyond exact matches
   Works across languages and terminology variations, with some models being multi-lingual.
   Scalable to large patent collections
   Enables fuzzy similarity matching
Other Similarity Methods:
   Euclidean Distance: d(A,B)=√Σ(ai−bi)²
   Dot Product: A·B=Σ(ai×bi)
   Jaccard Similarity (for sets)
   other metrics are possible

Referring to FIG. 26, it is appreciated that there might be situations where vectors have similar matching vectors, thus requiring specific cut-offs for determining future analysis, for example, decisions regarding patenting, licensing, ceasing production, etc.

For example, in the situation where a buffer zone of P almost matching vectors are identified, an off-line double checking system may be employed to identify more accurate matching. Such a system would utilize a flow chart as follows:

```
flowchart LR
  Q[User prompt] --> |embed [symbol]     2-3 ms| E [768-d vector]
  E --> |ANN search 1-2 ms| H{Top-P patented hits}
  H -->|score ≥ τ| A[License / Ad / Reject]
  H -->|no hit| N[Normal RAG, etc.]
```

Wherein,
E—Embedding
ANN—Approximate-Nearest-Neighbor index

Such a flow would work in the following manner. The prompt would be input to an LLM API call wherein variable results would be achieved based upon underlying uncertainty. These results would result in a range of answers that may be deployed as output.

Stabilizing variable LLM output is achieved in the following manner.

The prompt monitoring system 10 uses temperature=0 (which indicates least variability in the application of the program) where available. Using results averaging or other stabilization methods is also required. The prompt monitoring system 10 uses JSON return data or LLM's structured outputs to reduce the variability of LLM outputs and structure response, like with some OpenAI models and Google Gemini models. As part of the prompt, the prompt monitoring system 10 requests that return data contains confidence value by LLM itself. The prompt monitoring system 10 uses confidence and filters out those where confidence is less than 0.9 or some other high value. That threshold itself would be subject to tuning process. Further, the second round of LLM calls would be used to further scrutinize the return values and reduce the set of final answers. Obtain N (=20, 30) outputs with the confidence greater than or equal 0.9. The repeatable outcome required of the prompt monitoring system 10 is that a given set of patents that present most likely candidates for being infringed upon, coming from embeddings search and fine-tuned by running it through LLM, is fairly stable. Since for each retrieved patent, the decision is YES or NO—violate or not; For each potentially patentable prompt or general patent text, the final decision is YES or NO—so this makes it easier. The prompt monitoring system 10 needs to be able to reasonably well reproduce those YES/NO decisions. For total repeatability and zero variability, one could use open-source model with frozen and fixed all the parameters and weights.

The prompt monitoring system 10 also uses dimensionality reduction - PCA, t-SNE, UMAP to reduce dimensions of embeddings down to a smaller number, making it more stable. Then finding the centroid, and the closest choice, using cosine or other possible similar metric.

The prompt monitoring system 10 uses the LLM as an accessory generator for candidate [summaries/schemas/labels/parameters], not as the final arbiter. Multiple LLM outputs are subject to deterministic arbitration process.

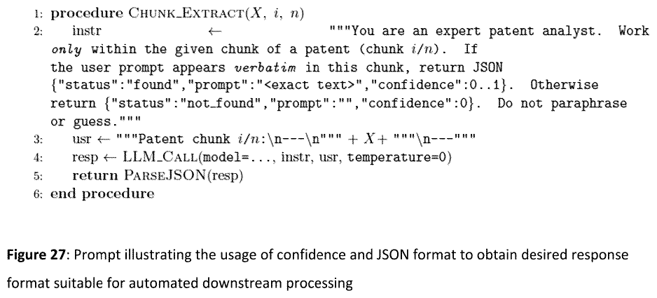

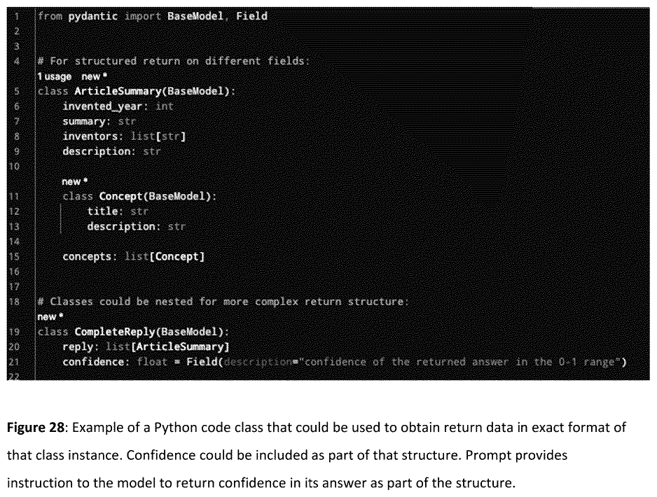

The prompt monitoring system 10 uses specific prompts to obtain JSON output and/or structured outputs where models support it (FIG. 27). As shown in FIG. 27, a prompt is shown illustrating the usage of confidence and JSON format to obtain desired response format suitable for automated downstream processing. Also structured outputs support requesting exact data structure to be returned as an instance of a class (FIG. 28). In FIG. 28 an example is shown of a Python code class that could be used to obtain return data in exact format of that class instance. Confidence could be included as part of that structure. The prompt provides instruction to the model to return confidence in its answer as part of the structure.

In addition, some variability in the final set of results is often useful to explore multiple possible choices in the complex questions—like patent infringement or patentability, which may actually help HUMAN-IN-THE-LOOP patent attorney make a better final choice.

As discussed above, the cut off for determining patentability or infringement relies upon a threshold determination. In accordance with the present invention, the determination of such a violation cut off threshold (VCT) is achieved through the utilization of expert feedback from patent attorneys and human reinforcement learning (HRL). In addition, violation cut off threshold (VCT) determinations could also be achieved using existing USPTO patent databases by considering the number of patents that were rejected due to similarity to previously granted patents, the number of patents that were approved despite similarities to previously granted patents (lawsuits, court challenges, . . . ), and a fine-tuned LLM using the information regarding the number of patents that were rejected due to similarity to previously granted patents and the information regarding the number of patents that were approved. Through the consideration of such data the present system is able to make determinations based upon the LLM fine-tuned for Binary Classification, separating violating and non-violating prompts and patents, etc.

In the event the vector check determines a close match with an existing patented prompt, a detailed patent violation check is performed. The specifics of such a detailed patent violation check are discussed below. In the event it is determined that the vector check produces no close results, the prompt monitoring system offers the possibility of patenting the prompt. In the event the user decides to patent the prompt, with the potential for revenue, the system will begin the process of patenting the prompt. In the event the user decides not to pursue patent protection, the prompt is sent the LLM in order to answer the prompt for the purpose of generating an answer. In addition, the prompt may also be incorporated into a large language model for future utilization in determinations in accordance with the present prompt monitoring system.

Returning to the situation where it is determined via the vector check that a prompt is a close match with a previously patented prompt and a patent infringement violation is possible, the prompt is subjected to a fine-tuned/custom LLM for a quick estimate regarding the patentability of the prompt. In the event it is determined that patentability is not possible, the new prompt is sent to the target LLM for the purpose of generating an answer. In the event it is determined that the prompt does offer the potential for patentability, the prompt is suggested to a fine-tuned slash custom LM for full patent evaluation via a patent attorney.

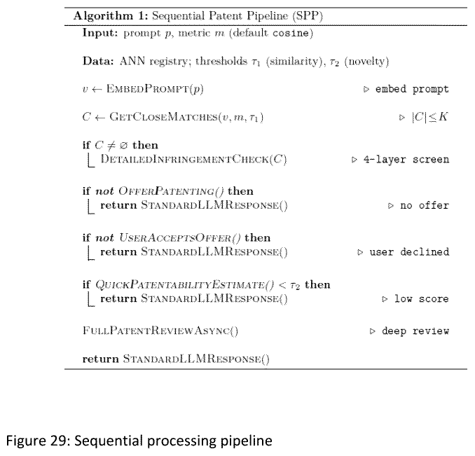

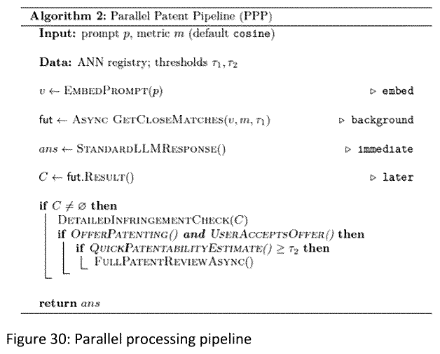

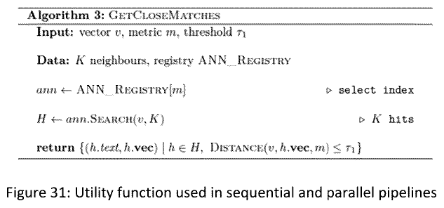

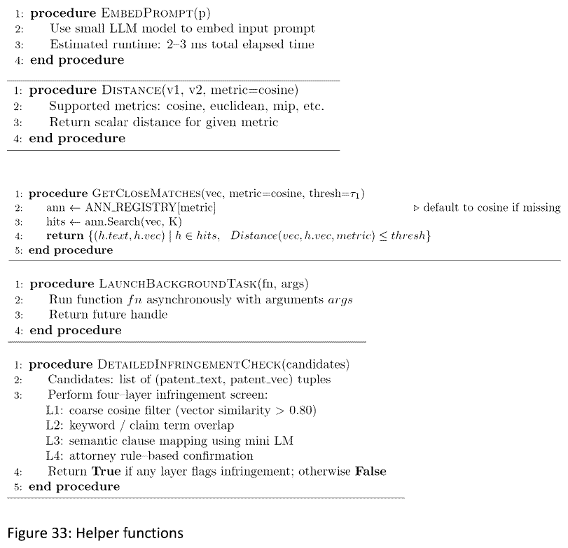

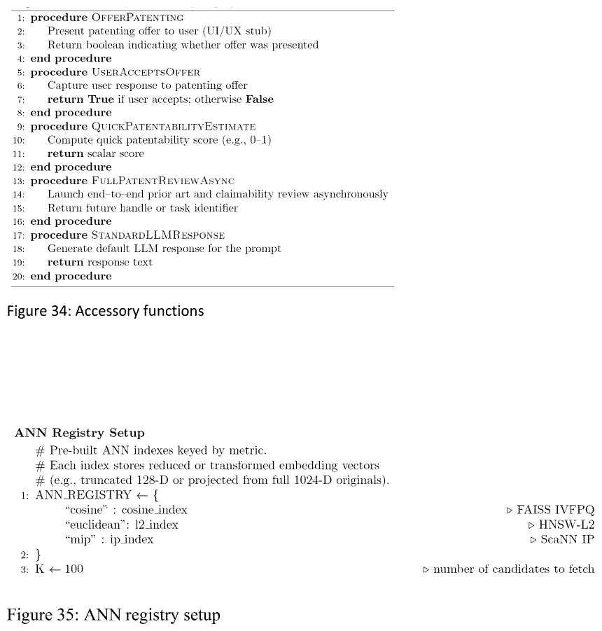

By way of example, various pseudocode algorithms for achieving the preceding vector processing are disclosed below(mathematical representations of the pseudocode are shown in FIGS. 29, 30 and 31).

| | === Listing 1A-Sequential Patent Pipeline (Fig. 29) === |
|---|---|
| 01 | # dim = embedding dimensionality |
| 02 | # tau1 = similarity threshold for chosen metric |
| 03 | # tau2 = novelty / value score threshold |
| 04 | # ------------------------------------------------------- |
| 05 | def process_prompt(prompt, metric=“cosine”): # 300 top entry |
| 06 | vec = embed_prompt(prompt) # 302 |
| 07 | candidates = get_close_matches( # 303 |
| 08 | vec, metric=metric, thresh=tau1) |
| 09 | if candidates: # 304 |
| 10 | detailed_infringement_check(candidates) # 306 |
| 11 | # else: no patent conflict # 308 |
| 12 | if not offer_patenting( ): # 310 |
| 13 | return standard_Ilm_response( ) # 320 |
| 14 | if not user_accepts_offer( ): # 312 |
| 15 | return standard_Ilm_response( ) # 320 |
| 16 | if quick_patentability_estimate( ) < tau2: # 314 |
| 17 | return standard_Ilm_response( ) # 320 |
| 18 | full_patent_review_async( ) # 316 |
| 19 | return standard_Ilm_response( ) # 320 |
| | === Listing 1B-Parallel Patent Pipeline (Figure 30) === |
| 01 | # dim = embedding dimensionality |
| 02 | # tau1 = similarity threshold for chosen metric |
| 03 | # tau2 = novelty / value score threshold |
| 04 | # ------------------------------------------------------- |
| 05 | def process_prompt(prompt, metric=“cosine”): # 300 top entry |
| 06 | vec = embed_prompt(prompt) # 302 |
| 07 | future = async_get_close_matches( # 303 |
| 08 | vec, metric=metric, thresh=tau1) |
| 09 | answer = standard_Ilm_response( ) # 320 |
| 10 | candidates = future.result( ) # 304 |
| 11 | if candidates: |
| 12 | detailed_infringement_check(candidates) # 306 |
| 13 | if offer_patenting( ) and user_accepts_offer( ): # 310/312 |
| 14 | if quick_patentability_estimate( ) >= tau2: # 314 |
| 15 | full_patent_review_async( ) # 316 |
| 16 | return answer # #320 |
| 17 | def async_get_close_matches(vec, metric, thresh): # helper 333 |
| 18 | “““Asynchronous wrapper for get_close_matches.””” |
| 19 | return launch_background_task( |
| 20 | get_close_matches, vec, metric, thresh) |

| | === Listing 2 - Shared Helper Routines (as applied in the algorithms |
|---|---|
| | disclosed with reference to Figures 29, 30, and 31) - wherein Figures 33-35 |
| | contain equivalent pseudocode, presented in LaTex typeset form .=== |
| 01 | # Helper routines |
| 02 | # ------------------------------------------------------- |
| 03 | def embed_prompt(p): # helper 330 |
| 04 | pass # small model (~2-3 ms) |
| 05 | def distance(v1, v2, metric=“cosine”): # helper 332 |
| 06 | “““Return scalar distance for given metric |
| 07 | metric in {‘cosine’, ‘euclidean’, ‘mip’, ... }””” |
| 08 | pass |
| 09 | # Pre-built ANN indexes keyed by metric. |
| 10 | # Each index stores reduced or transformed embedding vectors |
| | # (e.g., truncated 128-D or projected from full 1024-D originals). |
| 11 | ANN_REGISTRY = { |
| 12 | “cosine” : cosine_index, # FAISS IVFPQ |
| 13 | “euclidean”: 12_index, # HNSW-L2 |
| 14 | “mip” : ip_index # ScaNN IP |
| 15 | } |
| 16 | K = 100 # number of candidates to fetch |
| 17 | def get_close_matches(vec, metric=“cosine”, thresh=tau1): # helper |
| | 331 |
| 18 | “““Return (text, vec) pairs with distance <= thresh””” |
| 19 | ann = ANN_REGISTRY.get(metric, ANN_REGISTRY[‘cosine’]) |
| 20 | hits = ann.search(vec, k=K) |
| 21 | return [(h.text, h.vec) for h in hits |
| 22 | if distance(vec, h.vec, metric) <= thresh] |
| 23 | def launch_background_task(fn, *a): # helper 334 |
| 24 | “““Run fn asynchronously; return future.””” |
| 25 | pass |
| | detailed_infringement_check: |
| | Version 1: |
| | def detailed_infringement_check(candidates): # 306 detail |
| | ″″″ |
| | candidates: list of (patent_text, patent_vec) pairs |
| | ″″″ |
| | pass # run 4 layer screen over each pair |
| | Version 2: |
| | def detailed_infringement_check(candidates): # 306 detail |
| | ″″″ |
| | candidates: list of (patent_text, patent_vec) tuples |
| | Performs four layer infringement screen: |
| | L1 − coarse cosine filter (vector similarity > 0.80) |
| | L2 − keyword / claim term overlap |
| | L3 − semantic clause mapping using mini LM |
| | L4 − attorney rule based confirmation |
| | Returns True if any layer flags infringement. |
| | pass # implementation details omitted for brevity |
| 29 | def offer_patenting( ): # 310 helper |
| 30 | pass |
| 31 | def user_accepts_offer( ): # 312 helper |
| 32 | pass |
| 33 | def quick_patentability_estimate( ): # 314 helper |
| 34 | pass |
| 35 | def full_patent_review_async( ): # 316 helper |
| 36 | pass |
| 37 | def standard_Ilm_response( ): # 320 helper |
| 38 | pass |

```
procedure sequential_patent_pipeline(p, m=cosine)
  # Input: prompt p; metric m (default cosine)
  # Data: ANN registry; thresholds tau1 (similarity), tau2 (novelty)
  v = EmbedPrompt(p)  # embed prompt
  C = GetCloseMatches(v, m, tau1)  # at most K matches
  if C is not empty then
    DetailedInfringementCheck(C)  # 4-layer screen
  end if
  if not OfferPatenting( ) then
    return StandardLLMResponse( )  # no offer
  end if
  if not UserAcceptsOffer( ) then
    return StandardLLMResponse( )  # user declined
  end if
  if QuickPatentabilityEstimate( ) < tau2 then
    return StandardLLMResponse( )  # low score
  end if
  FullPatentReviewAsync( )  # deep review
  return StandardLLMResponse( )
end procedure
procedure get_close_matches(v, m, tau1)
  # Input: vector v; metric m; threshold tau1
  # Data: K neighbors; registry ANN_Registry
  ann = ANN_Registry[m]  # select index
  H = ann.Search(v, K)  # K hits
  return { (h.text, h.vec) for each h in H
  where Distance(v, h.vec, m) <= tau1 }
end procedure
procedure parallel_patent_pipeline(p, m=cosine)
  # Input: prompt p; metric m (default cosine)
  # Data: ANN registry; thresholds tau1 (similarity), tau2 (novelty)
  V = EmbedPrompt(p)  # embed
  fut = Async GetCloseMatches(v, m, tau1)  # background task
  ans = StandardLLMResponse( )  # immediate response
  C = fut. Result( )  # resolved later
  if C is not empty then
    DetailedInfringementCheck(C)
    if OfferPatenting( ) and UserAcceptsOffer( ) then
      if QuickPatentabilityEstimate( ) >= tau2 then
        FullPatentReviewAsync( )
      end if
    end if
  end if
  return ans
end procedure
```

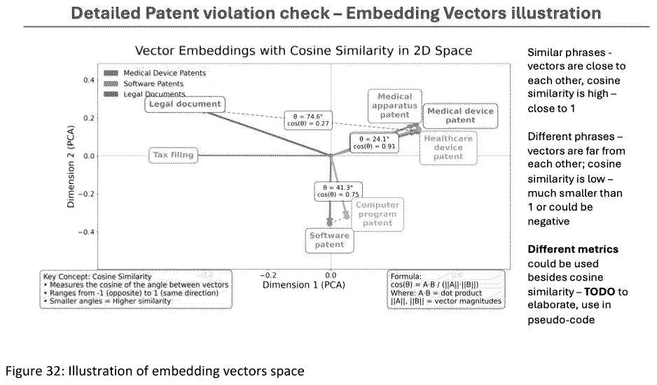

The vector check system described above ultimately results in the production of a user interface showing a detailed patent violation check. In accordance with this interface, a detailed patent violation check is provided with illustrations here showing the embedding vectors (FIG. 32). In accordance with the disclosed interface, prompts exhibiting similar phrases are shown as vectors that are close to each other, wherein the cosine is similarity is high—close to 1. Prompts exhibiting different phrases are shown as vectors are far from each other, wherein cosine is similarity. It is appreciated that different metrics could be used besides cosine similarity.

Similar to the diagram shown in FIG. 32, one may calculate multiple embeddings—short, medium, long for 10-15 million existing patents from the last 20 years (example: USPTO database yields about 5.3 million filed patents, 3.22 million granted since 2015).

Regarding the integration of the present prompt monitoring system 10, all the following possible applications disclosed herein sit on top of the prompt monitoring system 10 described above. In accordance with one implementation, the present prompt monitoring system may function as an innovation accelerator allowing researchers and R&D teams to quickly generate and validate innovative ideas in their field. It could help identify unexplored areas or novel combinations of existing technologies.

The present prompt monitoring system could also be implemented as a patent landscaping tool allowing companies to use this tool to understand the current state of patents in their industry. It could help identify white spaces for innovation and potential areas for new product development.

The present prompt monitoring system could also be implemented as a prior art search tool allowing inventors and patent attorneys to conduct more comprehensive prior art searches. It could help in assessing the novelty of an invention before filing a patent application.

The present prompt monitoring system could also be implemented as a competitive intelligence tool allowing Businesses to monitor competitors'potential innovations and patent strategies. It could help in identifying emerging trends and technologies in the industry.

The present prompt monitoring system could also be implemented as a cross-industry innovation tool suggesting novel applications of technologies from one industry to another. It could foster interdisciplinary innovation by combining ideas from different fields.

The present prompt monitoring system could also be implemented as a patent portfolio management tool allowing companies to identify gaps in their current patent portfolio. It could suggest new areas for patenting to strengthen their IP position.

The present prompt monitoring system could also be implemented as an idea validation for start-ups that allows entrepreneurs to quickly check if their startup ideas have already been patented. It could help in pivoting or refining ideas early in the development process.

The present prompt monitoring system could also be implemented in academic research wherein researchers could use this to ensure the novelty of their work and avoid unintentional infringement. It could suggest new research directions based on current patent landscapes.

The present prompt monitoring system could also be implemented as an IP monetization tool to help identify potential licensees or buyers for generated IP. The tool could suggest new applications for existing patents, potentially increasing their value.

The present prompt monitoring system could also be implemented as a Legal Risk Assessment tool to assist companies in assessing potential infringement risks for new products or services. It could help in developing “design-around” strategies to avoid patent infringement.

The present prompt monitoring system could also be implemented as a tool for technology forecasting. The tool could be used to predict future technological trends based on current patent activities. It could assist in long-term strategic planning for businesses and governments.

The present prompt monitoring system could also be implemented as a patent quality improvement tool that Patent Examiners could use to more efficiently identify relevant prior art. It could potentially lead to higher-quality patents being issued.

The present prompt monitoring system could also be implemented for Open Innovation Platforms that companies could use to generate and share innovation challenges with their ecosystem. It could facilitate collaboration between different entities on new IP development.

The present prompt monitoring system could also be implemented as an education and training tool to teach students about the patent system and innovation processes. It could serve as a practical tool for innovation workshops and brainstorming sessions.

The present prompt monitoring system could also be implemented for policy making purposes. Governments could use this to identify emerging technologies that may require new regulations or policies. It could help in assessing the impact of patent policies on innovation in different sectors.

Those skilled in the art will appreciate that the various illustrative logical blocks, modules, and algorithm steps described herein may be implemented as electronic hardware, computer software running on a specific purpose machine that is programmed to carry out the operations described in this application, or combinations of both. Whether the disclosed functionalities are implemented as hardware or software depends upon the particular application and design constraints.

Computer systems used in conjunction with the disclosed system can also have a user interface port that communicates with a user interface, and which receives commands entered by a user, and a video output that produces its output via any kind of video output format, e.g., VGA, DVI, HDMI, display port, or any other form. This may include laptop or desktop computers, and may also include portable computers, including cell phones, smartphones, tablets such as the IPAD™ and Android platform tablet, and all other kinds of computers and computing platforms. A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein. The steps of a method or algorithm described in connection with the embodiments disclosed herein may be embodied directly in hardware, in a software module executed by a processor, using cloud computing, or in combinations, using tangible computer programming.

While the preferred embodiments have been shown and described, it will be understood that there is no intent to limit the invention by such disclosure, but rather, is intended to cover all modifications and alternate constructions falling within the spirit and scope of the invention.

1. A prompt monitoring system for generative artificial intelligence systems, comprising:
a repository of prompts; and
a prompt analysis application analyzing prompts based upon intellectual property issues.

2. The prompt monitoring system according to claim 1, wherein the prompt analysis application identifies prompts that infringe existing patents, copyrights, or other intellectual property rights.

3. The prompt monitoring system according to claim 1, wherein the prompt analysis application identifies patentable prompts.

4. The prompt monitoring system according to claim 1, wherein the repository of prompts is a collection of prompts determined to infringe existing patents, copyrights, or other intellectual property rights.

5. The prompt monitoring system according to claim 4, wherein the repository of prompts also includes prompts that have been denied intellectual property protection and are considered to be in the public domain.

6. The prompt monitoring system according to claim 4, wherein the prompts maintained in the repository of prompts result from study of U.S. Patent & Trademark Office (USPTO) information, Copyright Office information, information from other government agencies responsible for intellectual property, court decisions concerning intellectual property, legal partners, and prompt creators.

7. The prompt monitoring system according to claim 1, wherein the prompt analysis application includes a Large Language Model.

8. The prompt monitoring system according to claim 7, wherein the Large Language Model is created by fine-tuning an existing Large Language Model with data, training a Large Language Model from scratch, building conventional Machine Learning models, or prompt engineering with a multi-shot approach, or combined with embedding searches.

9. The prompt monitoring system according to claim 1, wherein the repository of prompts is curated by legal partners and prompt creators studying patents issued by the USPTO and copyright registrations issued by the Copyright Office of the Library of Congress, and identify those relating to prompts.

10. The prompt monitoring system according to claim 1, wherein the prompt analysis application studies new prompts to determine whether they are patented, copyrighted, or otherwise protected by intellectual property.

11. The prompt monitoring system according to claim 1, wherein a human or AI prompt creator submits prompts to the prompt analysis application for consideration as to whether they are patented, copyrighted, or otherwise protected by intellectual property.

12. The prompt monitoring system according to claim 1, wherein a generative artificial intelligence system is connected to the repository of prompts and the prompt analysis application.

13. The prompt monitoring system according to claim 1, wherein the prompt analysis application determines a score relating to the likelihood a prompt presents a problem regarding intellectual property.

14. The prompt monitoring system according to claim 13, wherein a score that exceeds a predetermined threshold is considered to present a problem with regard to intellectual property.

15. The prompt monitoring system according to claim 1, wherein the prompt monitoring system further includes an interface providing screen notifications that allow for a user to request patent evaluation options, screen notifications that warn a user when a potential issue is identified, and/or options to explore new patent ideas associate with a given prompt.

16. The prompt monitoring system according to claim 1, wherein the prompt analysis application implements a vector processing system in its decision making process when determining a likelihood for either infringement or patentability.

17. The prompt monitoring system according to claim 16, wherein a prompt is first input into the prompt monitoring system and a vector check is performed to determine how closely the input prompt matches an existing patented prompt.

18. The prompt monitoring system according to claim 17, wherein vectors are generated based upon different information.

19. The prompt monitoring system according to claim 18, wherein an abstract of a patent is used to produce a short embedding vector.

20. The prompt monitoring system according to claim 18, wherein the full text, description, and images of a patent are used to produce a long embedding vector.
